(19) United States
(12) Patent Application Publication
(10) Pub. No.: US 2004/0228975 A1
(43) Pub. Date: Nov. 18, 2004

(54) Method for forming plural-layered coated film

(76) Inventors: Shoichi Takesako, Osaka-fu (JP); Daisuke Segawa, Osaka-fu (JP); Teruzo Toi, Osaka-fu (JP); Masahiro Yamauchi, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 10/842,514

(22) Filed: May 11, 2004

(30) Foreign Application Priority Data
May 13, 2003 (JP) 2003-134589

(51) Int. Cl. B05D 3/02

(52) U.S. Cl. 427/372.2

(57) ABSTRACT

The present invention is to provide a method for forming a plural-layered coated film which is excellent in surface smoothness while phase mixing between an intermediate coating film and a base coating film is effectively prevented. The method comprises coating successively an aqueous intermediate coating paint, an aqueous base paint and a clear paint on an electrodeposition coated film in a wet-on-wet manner, and baking and curing them at the same time, wherein an intermediate coating film formed of the aqueous intermediate coating paint has a water absorption rate of coating film of 10% or less and a water dissolving rate of coating film of 5%, and the aqueous intermediate coating paint contains an acrylic resin emulsion, a urethane resin emulsion, and a curing agent.

### FIELD OF THE INVENTION

The present invention relates to a method for forming a plural-layered coated film and, more particularly, to a method for forming an aqueous intermediate coating film and a top coating film on an automobile body using a three-coat one-bake method.

### BACKGROUND OF THE INVENTION

Paint coating of an automobile body is basically performed by successively coating an electrodeposition coated film, an intermediate coating film, and a top coating film composed of a base coating film and a clear coating film on a steel plate to be coated. Hitherto, these coating films have been formed by coating paint compositions having formulations adjusted depending on respective coating film functions, and baking and curing every coating film. When plural paints are coated by overlaying, unless a under-layer is completely formulated into a film and is flattened, adjacent coating film layers interfere with each other, irregularities of a substrate layer are reflected on upper layers, and appearance of a plural-layered coated film is deteriorated.

However, in order to increase operability and realize energy saving which has been particularly demanded recently, a method for forming a plural-layered coated film by coating plural paints by overlaying without baking and curing, and then curing them at the same time has been gradually adopted even in the field of automobile body coating.

Japanese Kokai Publication Hei 4-284881 describes a three-coat one-bake method for forming a plural-layered coated film, which comprises forming an electrocoated film on an article to be coated, coating an aqueous undercoating paint, an aqueous top coating paint and a clear paint by overlaying in a wet-on-wet manner, and curing the three-layers of the coating films at the same time. In this method, however, the conventional successive baking aqueous paints are coated by overlaying on an electrodeposition coated film. Accordingly, coating film layers are mixed with an adjacent layer and irregularities of a substrate layer are reflected on a surface, to give rise to a problem of deterioration of appearance of the resultant plural-layered coated film.

Japanese Kokai Publication Hei 8-33865 describes a two-coat one-bake method for forming a plural-layered coated film, which comprises forming an electrocoated film on an article to be coated, coating two kinds of aqueous paints by overlaying and curing two layers of coating film at the same time. In this method, phase mixing and phase inversion are prevented by controlling a neutralization value of two resin layers to be coated. However, the publication does not contain any explanation on how appearance of a plural-layered coated film is improved when a three-coat one-bake method is adopted.

Japanese Kokai Publication 2001-170559 describes a three-coat one-bake method for forming a plural-layered coated film, which comprises forming an electrocoated film and an intermediate coating film on an article to be coated, coating a base paint, a luster material-contained base paint and a clear paint by overlaying in a wet-on-wet manner, and baking and curing the three layers. In this method, however, since an intermediate coating film is baked and cured before a base paint is coated, energy saving and workability are not sufficient.

Japanese Kokai Publication 2001-205175 describes a three-coat one-bake method for forming a plural-layered coated film, which comprises forming an electrodeposition coated film on an article to be coated, coating an aqueous intermediate coating paint, an aqueous metallic base paint and a clear paint, and curing the three coating film layers at the same time. In this method, an aqueous intermediate coating paint contains an amide group-containing acrylic resin particle obtained by emulsion polymerization of an amide group-containing ethylenic unsaturated monomer and other ethylenic unsaturated monomer, which controls affinity and inversion at an interface of coating film layers and enhances an appearance of a plural-layered coated film. However, even in this method, smoothness of the surface of a plural-layered coated film is insufficiently improved and, therefore, it is still desired to improve appearance of a plural-layered coated film.

### OBJECT OF THE INVENTION

The present invention is to provide a method for forming a plural-layered coated film which has excellent surface smoothness by effectively preventing phase mixing of an intermediate coating film and a base coating film.

### SUMMARY OF THE INVENTION

The present invention provides a method for forming a plural-layered coated film, which comprises (1) a step of providing an article with an electrodeposition coating film; (2) a step of coating an aqueous intermediate coating paint on an electrodeposition coating film to form an intermediate coating film; (3) a step of successively coating an aqueous base paint and a clear paint on the intermediate coating film in a wet-on-wet manner without curing the intermediate coating film, to form a base coating film and a clear coating film; and (4) a step of baking and curing the intermediate coating film, the base coating film and the clear coating film at the same time,

wherein the intermediate coating film formed from the aqueous intermediate coating paint has a water absorption rate of coating film of 10% or less and a water dissolving rate of coating film of 5% or less, and

the aqueous intermediate coating paint comprises:

an acrylic resin emulsion having a glass transition temperature of −50 to 20° C., and an acid value of 2 to 60 mgKOH/g and a hydroxy group value of 10 to 120 mgKOH/g,

a urethane resin emulsion having an acid value of 5 to 50 mgKOH/g, and

a curing agent.

### DETAILED DESCRIPTION OF THE INVENTION

Aqueous Intermediate Coating Paint

The aqueous intermediate coating paint used in the present method contains an acrylic resin emulsion, a urethane resin emulsion and a curing agent in a state where they are dispersed or dissolved in an aqueous medium. The aqueous intermediate coating paint may further contain additives which are usually contained in an aqueous intermediate coating paint for automobiles, such as a pigment, a thickener and a filler.

The acrylic resin emulsion can be obtained by emulsion-polymerizing a monomer mixture containing (a) (meth)acrylic acid alkyl ester, (b) an acid group-containing ethylenic unsaturated monomer, and (c) a hydroxy group-containing ethylenic unsaturated monomer. Chemical compounds exemplified below as a component of the monomer mixture may be used alone or in combination of two or more.

The (meth)acrylic acid alkyl ester (a) is used for constituting a main skeleton of an acrylic resin emulsion.

Examples of the (meth)acrylic acid alkyl ester (a) include methyl (meth)acrylate, ethyl (meth)acrylate, propyl (meth)acrylate, n-butyl (meth)acrylate, isobutyl (meth)acrylate, t-butyl (meth)acrylate, hexyl (meth)acrylate, 2-ethylhexyl (meth)acrylate, octyl (meth)acrylate, nonyl (meth)acrylate, decyl (meth)acrylate, dodecyl (meth)acrylate, and stearyl (meth)acrylate.

The acid group-containing ethylenic unsaturated monomer (b) is used for improving various stabilities such as storage stability, mechanical stability, and stability to freezing of the resulting acrylic resin emulsion, and accelerating a curing reaction with a curing agent such as a melamine resin at formation of a coating film. It is preferable that an acid group is selected form a carboxyl group, a sulfonic acid group and a phosphoric acid group. A particularly preferable acid group is a carboxyl group from a viewpoint of improvement of various stabilities and curing reaction accelerating function.

Examples of the carboxyl group-containing ethylenic unsaturated monomer include acrylic acid, methacrylic acid, crotonic acid, isocrotonic acid, ethacrylic acid, propylacrylic acid, isopropylacrylic acid, itaconic acid, maleic acid anhydride and fumaric acid. Examples of the sulfonic acid group-containing ethylenic unsaturated monomer include p-vinylbenzenesulfonic acid, p-acrylamidopropanesulfonic acid, and t-butylacrylamidosulfonic acid. Examples of the phosphoric acid group-containing ethylenic unsaturated monomer include Light Ester PM (manufactured by Kyoeisha Chemical Co., Ltd.) such as phosphoric acid monoester of 2-hydroxyethyl acrylate, and phosphoric acid monoester of 2-hydroxypropyl methacrylate.

The hydroxy group-containing ethylenic unsaturated monomer (c) is used for imparting hydrophilicity based on a hydroxy group to an acrylic resin emulsion, thus increasing workability when used in paint, and stability to freezing and, at the same time, imparting curing reactivity with a melamine resin and an isocyanate-based curing agent.

Examples of the hydroxy group-containing ethylenic unsaturated monomer (c) include 2-hydroxyethyl (meth)acrylate, 2-hydroxypropyl (meth)acrylate, 4-hydroxybutyl (meth)acrylate, N-methylolacrylamide, allyl alcohol, and ε-caprolactone-modified acrylic monomer.

Examples of the ε-caprolactone-modified acrylic monomer include “Placcel FA-1”, “Placcel FA-2”, “Placcel FA-3”, “Placcel FA4”, “Placcel FA-5”, “Placcel FM-1”, “Placcel FM-2”, “Placcel FM-3”, “Placcel FM4” and “Placcel FM-5” manufactured by Daicel Chemical Industries, Ltd.

The monomer mixture may contain, as an arbitrary component, at least one kind of a monomer selected from the group consisting of a styrene-based monomer, (meth)acrylonitrile and (meth)acrylamide. Examples of the styrene-based monomer include α-methylstyrene and styrene.

The monomer mixture may also contain a cross-linkable monomer, such as a carbonyl group-containing ethylenic unsaturated monomer, a hydrolysis polymerizable silyl group-containing monomer, and various polyfunctional vinyl monomers. In this case, the resulting acrylic resin emulsion is self-cross-linkable.

Examples of the carbonyl group-containing monomer include monomers containing a keto group such as acrolein, diacetone(meth)acrylamide, acetoacetoxyethyl (meth)acrylate, formylstyrol, and alkyl vinyl ketone having 4 to 7 carbon atoms (e.g. methyl vinyl ketone, ethyl vinyl ketone, butyl vinyl ketone). Among them, diacetone(meth)acrylamide is preferable. When such carbonyl group-containing monomer is used, a hydrazine-based compound as a cross-linking aid is added to an acrylic resin emulsion so that a cross-linked structure is formed at formation of a coating film.

Examples of the hydrazine-based compound include saturated aliphatic carboxylic acid dihydrazide having 2 to 18 carbon atoms, such as oxalic acid dihydrazide, malonic acid dihydrazide, glutaric acid dihydrazide, succinic acid dihydrazide, adipic acid dihydrazide, and sebacic acid dihydrazide; monoolefinic unsaturated dicarboxylic acid dihydrazide such as maleic acid dihydrazide, fumaric acid dihydrazide, and itaconic acid dihydrazide; phthalic acid dihydrazide, terephthalic acid dihydrizide, isophthalic acid dihydrazide, and pyromellitic acid dihydrazide, trihydrazide or tetrahydrazide; nitrilotrihydrazide, citric acid trihydrazide, 1,2,4-benzenetrihydrazide, ethylenediaminetetraacetic acid tetrahydrazide, 1,4,5,8-naphthoic acid tetrahydrazide, and polyhydrazide obtained by reacting a low-molecular polymer having a carboxylic acid lower alkyl ester group with hydrazine or hydrazine hydrate; carbonic acid dihydrazide, bissemicarbazide; aqueous polyfunctional semicarbazide obtained by exceessively reacting a hydrazine compound or above exemplified dihydrazide with diisocyanate such as hexamethylene diisocyanate and isophorone diisocyanate or a polyisocyanate compound derived therefrom.

Examples of the hydrolysis polymerizable silyl group-containing monomer include monomers containing an alkoxysilyl group such as γ-(meth) acryloxypropylmethyldimethoxysilane, γ-(meth)acryloxypropylmethyldiethoxysilane, and γ-(meth)acryloxypropyltriethoxysilane.

The polyfunctional vinyl-based monomer is a compound having two or more radical polymerizable ethylenic unsaturated groups in a molecule, and examples include divinyl compounds such as divinylbenzene, ethylene glycol di(meth)acrylate, hexanediol di(meth)acrylate, polyethylene glycol di(meth)acrylate, allyl (meth)acrylate, 1,4-butanediol di(meth)acrylate, 1,6-hexane di(meth)acrylate, neopentyl glycol di(meth)acrylate, and pentaerythritol di(meth)acrylate, as well as pentaerythritol tri(meth)acrylate, trimethylolpropane tri(meth)acrylate, and dipentaerythritol hexa(meth)acrylate.

Emulsion copolymerization can be performed by heating the monomer mixture while stirring, in an aqueous solution, in the presence of a radical polymerization initiator and an emulsifying agent. When a reaction temperature is, for example, around 30 to 100° C., a reaction time is preferably around 1 to 10 hours. A reaction temperature may be regulated by adding at once or adding dropwise the monomer mixture or a monomer pre-emulsified solution to a reaction vessel in which water and an emulsifying agent are placed.

As the radical polymerization initiator, the known initiators which are usually used in emulsion polymerization of an acrylic resin can be used. Specifically, as a water-soluble free radical polymerization initiator, for example, persulfate such as potassium persulfate, sodium persulfate and ammonium persulfate is used in the form of an aqueous solution. In addition, a so-called redox system initiator in which an oxidizing agent such as potassium persulfate, sodium persulfate, ammonium persulfate and hydrogen peroxide, and a reducing agent such as sodium hydrogen sulfite, sodium thiosulfate, Rongalit and ascorbic acid are combined, is used in the form of an aqueous solution.

As an emulsifying agent, an anionic or nonionic emulsifying agent selected from micelle compounds having a hydrocarbon group having 6 or more carbon atoms, and a hydrophilic part such as carboxylic acid salt, sulfonic acid salt or sulfuric acid salt hemiester in the same molecule is used. Among them, examples of the anionic emulsifying agent include an alkali metal salt or an ammonium salt of a sulfuric acid hemiester of alkylphenols or higher alcohols; an alkali metal salt or an ammonium salt of alkyl or allyl sulfonate; and an alkali metal salt or an ammonium salt of a sulfuric acid hemiester of polyoxyethylene alkyl phenyl ether, polyoxyethylene alkyl ether or polyoxyethylene allyl ether. In addition, examples of the nonionic emulsifying agent include polyoxyethylene alkyl phenyl ether, polyoxyethylene alkyl ether or polyoxyethylene allyl ether. In addition to these general-use anionic and nonionic emulsifying agents, various anionic or nonionic reactive emulsifying agents having a radical polymerizable unsaturated double bond in a molecule, that is, having a group such as acrylic series, methacrylic series, propenyl series, allyl series, allyl ether series, and maleic acid series, can be appropriately used alone or in combination of two or more.

Upon emulsion polymerization, an additive for regulating a molecular weight (chain transfer agent), such as a mercaptan-based compound and a lower alcohol is used in many cases in view of accelerating emulsion polymerization, promoting smooth and uniform formation of a coating film and improving adhering ability to a substrate.

As emulsion polymerization, any polymerization method may be adopted, such as a one-stage method of continuously adding a monomer dropwise uniformly, a core/shell polymerization method which is a multi-stage monomer feeding method, and a power feed polymerization method for continuously changing a composition of a monomer which is fed during polymerization.

As mentioned above, an acrylic resin emulsion used in the present invention is prepared. A weight average molecular weight of the resulting acrylic resin is not particularly limited but is generally around 50,000 to 1,000,000, for example, around 100,000 to 800,000.

A glass transition temperature (Tg) of an acrylic resin is in a range of −50° C. to 20° C., preferably −40° C. to 10° C., more preferably −30° C. to 0° C. By adjusting Tg of the resin within these ranges, when an aqueous intermediate coating paint containing an acrylic resin emulsion is used in a wet-on-wet format, affinity and adhesion between an undercoating paint and a top coating paint are improved, affinity at an interface between upper coating films in the wet state is enhanced, and inversion does not occur. Suitable softness of the final coating film is obtained, and anti-chipping property is enhanced. As a result, a plural-layered coated film having very good appearance can be formed. When Tg of a resin is lower than −50° C., mechanical strength of a coated film is insufficient, and anti-chipping property is weak. On the other hand, when Tg of a resin is higher than 20° C., since a coated film is hard and brittle, anti-impact resistance is deficient, and anti-chipping property is weakened. A kind and an amount of the respective monomer components can be selected such that Tg of the resin is in the above range.

An acid value of an acrylic resin is within a range of 2 to 60 mgKOH/g, preferably 5 to 50 mgKOH/g. By adjusting an acid value of the resin within these ranges, various stabilities, such as storage stability, mechanical stability, and stability to freezing of a resin emulsion and an aqueous intermediate coating paint are improved, and a curing reaction with a curing agent such as a melamine resin at formation of a coating film sufficiently occurs, and various strengths, anti-chipping property and water resistance of a coated film are improved. When an acid value of a resin is smaller than 2 mgKOH/g, the above stabilities are inferior, a curing reaction with a curing agent such as a melamine resin is not sufficiently performed, and the strengths, anti-chipping property and water resistance of a coated film are inferior. On the other hand, when an acid value of a resin exceeds 60 mgKOH/g, polymerization stability of a resin is deteriorated, and the stabilities are conversely deteriorated, leading to inferior water resistance of the resulting coated film. A kind and an amount of the various monomer components can be selected so that an acid value of a resin is in the above range. As described above, among the acid group-containing ethylenic unsaturated monomer (b), it is important to use a carboxyl group-containing monomer. Among the monomer (b), a carboxyl group-containing monomer is contained preferably at 50% by weight or more, more preferably at 80% by weight or more.

A hydroxy group value of an acrylic resin is in a range of 10 to 120 mgKOH/g, preferably 20 to 100 mgKOH/g. By adjusting a hydroxy group value of the resin within these ranges, the resin has suitable hydrophilicity, workability and stability to freezing when used as a paint composition containing a resin emulsion. Curing reactivity with a melamine resin and an isocyanate-based curing agent is also enhanced. When a hydroxy group value is smaller than 10 mgKOH/g, the curing reaction with a curing agent is insufficient, mechanical property of a coated film is weak, anti-chipping property is deficient, and water resistance and solvent resistance are inferior. On the other hand, when a hydroxy group value exceeds 120 mgKOH/g, water resistance of the resulting coated film is conversely reduced, compatibility with the curing agent is deteriorated, a strain occurs in a coated film, a curing reaction occurs ununiformely and, as a result, various strengths, particularly anti-chipping property, solvent resistance and water resistance of a coated film are inferior. A kind and an amount of the respective monomer components are selected so that a hydroxy group value of a resin is in the range.

A basic compound is added to the resulting acrylic resin emulsion in order to neutralize a part or all of carboxylic acid to retain stability of an acrylic resin emulsion. As the basic compound, usually, ammonia, various amines, and an alkali metal are appropriately used in the present invention.

The urethane emulsion in the present invention has an acid value from a viewpoint of curability and stability as in the acrylic emulsion. An acid value of a urethane emulsion is 5 to 50 mgKOH/g. When an acid value exceeds 50 mgKOH/g, coated film performance is reduced and, when an acid value is below 5 mgKOH/g, stability is reduced. In addition, a urethane emulsion can have a hydroxy group value. It is preferable that a hydroxy group value is not greater than 100 mgKOH/g. When a hydroxy group value exceeds 100 mgKOH/g, coated film performance is reduced.

The urethane resin emulsion can be prepared, for example, as follows, without any limitation. First, diisocyanate, and glycol and glycol having a carboxylic acid are reacted to make a urethane prepolymer. Then, a urethane resin emulsion is obtained by neutralizing the prepolymer, extending a chain thereof, and adding distilled water.

Examples of the diisocyanate used in preparation of a urethane prepolymer is not particularly limited, but include aliphatic, alicyclic or aromatic diisocyanate, for example 2,4-tolylene diisocyanate, 2,6-tolylene diisocyanate, 4,4′-diphenylmethane diisocyanate, m-phenylene diisocyanate, xylylene diisocyanate, tetramethylene diisocyanate, hexamethylene diisocyanate, lysine diisocyanate ester, 1,4-cyclohexylene diisocyanate, 4,4′-dicyclohexylmethane diisocyanate, 3,3′-dimethyl-4,4′-biphenylene diisocyanate, 3,3′-dimethoxy-4,4′-biphenylene diisocyanate, 1,5-naphthalene diisocyanate, 1,5-tetrahydronaphthalene diisocyanate and isophorone diisocyanate.

The glycols are not particularly limited, but examples include low-molecular glycols, such as ethylene glycol, diethylene glycol, triethylene glycol, 1,2-propylene glycol, trimethylene glycol, 1,3-butylene glycol, tetramethylene glycol, hexamethylene glycol, hydrogenated bisphenol A, and ethylene oxide or propylene oxide adduct of bisphenol A, as well as polyethylene glycol which is polyol, polyethers such as polypropylene glycol, and polyesters which is a fused compound of ethylene glycol and adipic acid, hexanediol and adipic acid, and ethylene glycol and phthalic acid, and polycaprolactone.

In addition, the glycol having a carboxylic acid group is not particularly limited, but examples include 2,2-dimethylolpropionic acid, 2,2-dimethylolbutyric acid, and 2,2-dimethylolvaleric acid. The raw materials are reacted to obtain a urethane prepolymer, which is neutralized and chain-extended, followed by addition of distilled water to obtain a urethane resin emulsion. A neutralizing agent used thereupon is not particularly limited, but examples include amines such as dimethylethanolamine, trimethylamine, triethylamine, tri-n-propylamine, tributylamine, and triethanolamine, sodium hydroxide, potassium hydroxide, and ammonia.

The chain extending agent is not particularly limited, but example include polyols, such as ethylene glycol, and propylene glycol, aliphatic, alicyclic or aromatic diamine such as ethylenediamine, propylenediamine, hexamethylenediamine, tolylenediamine, xylylenediamine, diphenyldiamine, diaminodiphenylmethane, diaminocyclohexylmethane, piperazine, 2-methylpiperazine, and isophoronediamine, and water.

Examples of a commercially available product of the urethane resin emulsion which can be used in the presence invention is not particularly limited, but include “VONDIC”, and “HYDRAN” series manufactured by Dainippon Ink and Chemicals, Incorporated, “SUPERFLEX” series manufactured by Dai-ichi Kogyo Seiyaku Co., Ltd., and “ADEKA BONTIGHTER” series manufactured by Asahi Denca Co., Ltd.

The urethane resin emulsions may be used alone or in combination of two or more.

Further, a urethane resin emulsion obtained by reacting diisocyanate and polyether or polyester can be used. The diisocyanate can be those listed above.

The polyether is one containing at least two active hydrogens. Representative examples thereof include polyoxypropylene glycols, adduct of polyoxypropylene and glycerin, adduct of polyoxypropylene and trimethylolpropane, adduct of polyoxypropylene and 1,2,6-hexanetriol, adduct of polyoxypropylene and pentaerythritol, adduct of polyoxypropylene and sorbit, methylene-bis-phenyl diisocyanate, and polytetrafuran polyether obtained by chain extension with hydrazine, and derivatives thereof.

Also as polyester, polyesters having at least two active hydrogens are used. Representative examples include reaction products of adipic acid or phthalic acid anhydride, with ethylene glycol, propylene glycol, 1,3-butylene glycol, 1,4-butylene glycol, diethylene glycol, 1,2,6-hexanetriol, trimethylolpropane or 1,1,1-trimethylolethane.

This emulsion can be obtained by dispersing the reaction product of the polyether or polyester and excessive diisocyanate in water using a cationic, nonionic or anionic surfactant, and extending a chain thereof with primary diamine (e.g. ethylenediamine, m-tolylenediamine etc.) or 1,2-bis-(2-cyanoethylamino)ethane.

Among the polyethers, when polyether having 3 or more hydroxyl groups in one molecule is used, to this polyether is added an excessive isocyanate compound to react them, then, remaining NCO group is inactivated with phenol to prepare a blocked isocyanate compound, which can be dispersed in water in the presence of a nonionic surfactant to obtain a desired urethane resin emulsion.

The curing agent is not particularly limited as far as it can cause a curing reaction with an acrylic resin or a urethane resin contained as an emulsion, and can be incorporated into an aqueous intermediate coating paint. Examples thereof include a melamine resin, an isocyanate resin, an oxazoline-based compound and a carbodiimide-based compound. The compounds can be used alone or in combination of two or more.

The melamine resin is not particularly limited, but melamine resins which are usually used as a curing agent can be used.

For example, an alkyletherized melamine resin is preferable, and a melamine resin substituted with a methoxy group and/or a butoxy group is more preferable. Examples of such melamine resin include CYMEL 325, CYMEL. 327, CYMEL 370, and MYCOAT 723 as a melamine resin having a methoxy group alone; CYMEL 202, CYMEL 204, CYMEL 232, CYMEL 235, CYMEL 236, CYMEL 238, CYMEL 254, CYMEL 266, and CYMEL 267 (all trade name manufactured by Mitsui Cytec Inc.) as a melamine resin having both of a methoxy group and a butoxy group; Mycoat506 (trade name, manufactured by Mitsui Cytec Inc.), U-VAN 20N60 and U-VAN 20SE (all trade name, manufactured by Mitsui Chemicals, Inc.) as a melamine resin having a butoxy group alone. These may be used alone or in combination of two or more. Among these, CYMEL 325, CYMEL 327, and Mycoat 723 are more preferable.

The isocyanate resin is one that a diisocyanate compound is blocked with a suitable blocking agent. The diisocyanate compound is not particularly limited as far as it is a compound having two or more isocyanate groups in one molecule, and examples thereof include aliphatic diisocyanates such as hexamethylene diisocyanate (HMDI), and trimethylhexamethylene diisocyanate (TMDI); alicyclic diisocyanates such as isophorone diisocyanate (IPDI); aromatic-aliphatic diisocyanates such as xylylene diisocyanate (XDI); aromatic diisocyanates such as tolylene diisocyanate (TDI) and 4,4-diphenylmethane diisocyanate (MDI); hydrogenated diisocyanates such as dimer acid diisocyanate (DDI), hydrogenated TDI (HTDI), hydrogenated XDI (H6XDI), and hydrogenated MDI (H12MDI), and adduct and nurate of the diisocyanates. Further, the isocyanate can be used alone or in combination of two or more.

The blocking agent for blocking the diisocyanate compound is not particularly limited, but examples include oximes such as methylethylketoxime, acetoxime, and cyclohexanoneoxime; phenols such as m-cresol, and xylenol; alcohols such as butanol, 2-ethylhexanol, cyclohexanol, and ethylene glycol monoethyl ether; lactams such as ε-caprolactam; diketones such as diethyl malonate, and acetoacetic acid ester; mercaptans such as thiophenol; ureas such as thiouric acid; imidazoles; carbamic acids. Inter alia, oximes, phenols, alcohols, lactams and diketones are preferable.

The oxazoline-based compound is preferably a compound having two or more 2-oxazoline groups, and the examples include the following oxazolines and an oxazoline group-containing polymer. The compounds can be used alone or in combination of two or more. The oxazoline-based compound is obtained by using a method for dehydrating and cycling amido alcohol by heating in the presence of a catalyst, a method for synthesizing from alkanolamine and nitrile, or a method for synthesizing from alkanolamine and carboxylic acid.

Examples of oxazolines include 2,2′-bis-(2-oxazoline), 2,2′-methylene-bis-(2-oxazoline), 2,2′-ethylene-bis-(2-oxazoline), 2,2′-trimethylene-bis-(2-oxazoline), 2,2′-tetramethylene-bis-(2-oxazoline), 2,2′-hexamethylene-bis-(2-oxazoline), 2,2′-octamethylene-bis-(2-oxazoline), 2,2′-ethylene-bis-(4,4′-dimethyl-2-oxazoline), 2,2′-p-phenylene-bis-(2-oxazoline), 2,2′-m-phenylene-bis-(2-oxazoline), 2,2′-(m-phenylene-bis-(4,4′-dimethyl-2-oxazoline), bis-(2-oxazolinylcyclohexane) sulfide, and bis-(2-oxazolinylnorbornane) sulfide. The compounds can be used alone or in combination of two or more.

The oxazoline group-containing polymer is one that addition polymerizable oxazoline and, if needed, at least one kind of other polymerizable monomer are polymerized. Example of the addition polymerizable oxazoline include 2-vinyl-2-oxazoline, 2-vinyl methyl-2-oxazoline, 2-vinyl-5-methyl-2-oxazoline, 2-isopropenyl-2-oxazoline, 2-isopropenyl-4-methyl-2-oxazoline, and 2-isopropenyl-5-ethyl-2-oxazoline. The monomers can be used alone or in combination of two or more. Inter alia, 2-isopropenyl-2-oxazoline is industrially easily available, being preferable.

An amount of addition polymerizable oxazoline to be used is not particularly limited, but it is preferably 1% by weight or larger in an oxazoline group-containing polymer. When the amount is smaller than 1% by weight, curing is insufficient, and durability and water resistance are deteriorated.

Other polymerizable monomer is not particularly limited as far as it is a monomer which is copolymerizable with addition polymerizable oxazoline and does not react with an oxazoline group, and examples include (meth)acrylic acid esters such as methyl (meth)acrylate, butyl (meth)acrylate, and 2-ethylhexyl (meth)acrylate; unsaturated nitriles such as (meth)acrylonitrile; unsaturated amides such as (meth)acrylamide, and N-methylol (meth)acrylamide; vinyl esters such as vinyl acetate, and vinyl propionate; vinyl ethers such as methyl vinyl ether and ethyl vinyl ether; α-olefins such as ethylene and propylene; halogenated α,β-unsaturated monomers such as vinyl chloride, vinylidene chloride and vinyl fluoride; and α,β-unsaturated aromatic monomers such as styrene, and α-methylstyrene. The monomers can be used alone or in combination of two or more.

The oxazolizine group-containing polymer can be prepared by subjecting an addition-polymerizable oxazoline and, if needed, at least one kind of other polymerizable monomer to an art known polymerization method, such as suspension polymerization, solution polymerization or emulsion polymerization. The oxazolizine group-containing compound can be formulated in the form of an organic solvent solution, an aqueous solution, a non-aqueous dispersion, and an emulsion, but these are non-limiting examples.

Carbodiimide compounds prepared by various methods can be used, and basical examples include carbodiimide compounds obtained by synthesizing an isocyanate-terminal polycarbodiimide by a condensing reaction of organic diisocyanate accompanied with de-carbon dioxide. More specifically, a preferable example includes a hydrophilization-modified carbodiimide compound obtained by a step of reacting a polycarbodiimide compound containing at least two isocyanate groups in one molecule, and polyol having a hydroxy group at a molecular terminal at such a ratio that a mol amount of an isocyanate group of the polycarbodiimide compound is larger than a mol amount of a hydroxy group of the polyol, and a step of reacting a hydrophilizing agent having active hydrogen and a hydrophilic part with the reaction product obtained by the step, in preparation of a polycarbodiimide compound.

The carbodiimide compound containing at least two isocyanate groups in one molecule is not particularly limited, but is preferably a carbodiimide compound having an isocyanate group at both terminals from a viewpoint of reactivity. A process for preparing a carbodiimide compound having an isocyanate group at both terminals is well-known to a person skilled in the art. For example, a condensation reaction of organic diisocyanate accompanied with de-carbon dioxide can be utilized.

The aqueous intermediate coating paint used in the present invention may further contain components such as additional resin components, pigment dispersion paste, thickener, and other additives.

The additional resin components are not particularly limited, but examples include a polyester resin, an acrylic resin, a carbonate resin and an epoxy resin.

The pigment dispersion paste is obtained by dispersing a pigment and a pigment dispersant in a small amount of an aqueous medium. A solid matter of the pigment dispersant does not contain volatile basic substances at all, or contains volatile basic substances in an amount of 3% by weight or less. In the aqueous intermediate coating paint used in the present invention, the use of the pigment dispersant reduces an amount of volatile basic substances in a coating film formed from an aqueous intermediate coating paint to suppress yellowing of the resulting plural-layered coated film. Therefore, when volatile basic substances are contained in an amount of 3% by weight or more in a solid matter of a pigment dispersant, the resulting plural-layered coated film shows yellowing and a finished appearance is deteriorated.

The term “volatile basic substances” means basic substances having a boiling point of 300° C. or lower, of which examples include inorganic and organic nitrogen-containing basic substances. Examples of inorganic basic substances include ammonia. Examples of organic basic substances include amines such as linear or branched alkyl group-containing primary to tertiary amines having a carbon number of 1 to 20 such as methylamine, dimethylamine, trimethylamine, ethylamine, diethylamine, triethylamine, isopropylamine, diisopropylamine, and dimethyldodecylamine; linear or branched hydroxyalkyl gorup-containing priamry to tertiary amines having a carbon number of 1 to 20 such as monoethanolamine, diethanolamine and 2-amino-2-methylpropanol; primary to tertiary amines containing a linear or branched hydroxyalkyl group having a carbon number of 1 to 20, such as dimethylethanolamine, and diethylethanolamine; substituted or unsubstituted linear polyamines having a carbon number of 1 to 20 such as diethylenetriamine, and triethylenetetramine; substituted or unsubstituted cyclic monoamines having a carbon number of 1 to such as morpholine, N-methylmorpholine, and N-ethylmorpholine; substituted or unsubstituted cyclic polyamines having a carbon number of 1 to such as piperazine, N-methylpiperazine, N-ethylpiperazine, and N,N-dimethylpiperazine.

The aqueous intermediate coating paint used in the present invention contains volatile basic substances in some cases in addition to the pigment dispersant. Therefore, the less the amount of the volatile basic substance contained in the pigment dispersant the better. That is, it is preferable that dispersing is performed using a pigment dispersing resin which contains substantially no volatile basic substances. In addition, it is further preferable that an amine neutralization-type pigment-dispersing resin which has been generally used in this field is not used. And, it is preferable to use a pigment dispersant so that an amount of volatile basic substances per unit area 1 mm² is 7×10⁻⁶ mmol or less at formation of a plural-layered coated film.

The pigment dispersant is a resin having a structure containing both a pigment affinity part and a hydrophilic part. Examples of the pigment affinity part and the hydrophilic part include nonionic, cationic and anionic functional groups. The pigment dispersant may have two or more kinds of the functional groups in one molecule.

Examples of the nonionic functional group include a hydroxyl group, an amide group and a polyoxyalkylene group. Examples of the cationic functional group include an amino group, an imino group and a hydrazino group. Examples of the anionic functional group include a carboxyl group, a sulfonic acid group and a phosphoric acid group. The pigment dispersant can be prepared by methods which are well-known to a person skilled in the art.

The pigment dispersant is not particularly limited as far as a solid matter thereof does not contain volatile basic substances, or contains the volatile basic substances in an amount of 3% by weight or less. It is preferable that a pigment can be effectively dispersed using a small amount of a pigment dispersant. For example, commercially available dispersants (hereinafter, all trade name) may be used. Specific examples include Disperbyk 190, Disperbyk 181, Disperbyk 182 (polymer copolymer), and Disperbyk 184 (polymer copolymer) manufactured by Byk-Chemie which are an anionic or nonionic dispersant, EFKAPOLYMER4550 manufactured by EFKA which is an anionic or nonionic dispersant, Solsperse27000 manufactured by Avecia KK which is a nonionic dispersant, and Solsperse41000, and Solsperse53095 which are an anionic dispersant.

The pigment dispersant preferably has a number average molecular weight of 1,000 to 100,000. When the molecular weight is smaller than 1,000, dispersion stability is not sufficient in some cases. When the molecular weight exceeds 100,000, viscosity is too high to handle in some cases. More preferably, a lower limit is 2,000 and an upper limit is 50,000. More preferably, a lower limit is 4,000 and an upper limit is 50,000.

The pigment dispersion paste can be obtained by mixing and dispersing a pigment dispersant and a pigment according to an art-known method. It is preferable that a ratio of a pigment dispersant at preparation of a pigment dispersion paste is a lower limit of 1% by weight and an upper limit of 20% by weight relative based on a solid content of the pigment dispersion paste. When the ratio is smaller than 1% by weight, it is difficult to disperse a pigment stably. When the ratio exceeds 20% by weight, physical properties of a coated film are inferior. Preferably, the lower limit is 5% by weight and the upper limit is 15% by weight.

The pigment is not particularly limited as far as it is used in a conventional aqueous paint, but in order to improve weather resistance and ensure opacifying properties, the pigment can preferably be a coloring pigment. In particular, titanium dioxide is preferred, because titanium dioxide is excellent in both coloring properties and opacifying properties and is inexpensive.

Examples of the pigment other than titanium dioxide include organic coloring pigments such as an azo chelate-based pigment, an insoluble azo-based pigment, a fused azo-based pigment, a phthalocyanine-based pigment, an indigo pigment, a perinone-based pigment, a perylene-based pigment, a dioxane-based pigment, a quinacridone-based pigment, an isoindolinone-based pigment, a diketopyrrolopyrrole-based pigment, a benzimidazolone-based pigment, and a metal complex pigment; inorganic coloring pigments such as chrome yellow, yellow iron oxide, red oxide, and carbon black. Filler pigments such as calcium carbonate, barium sulfate, clay and talc may be used with the pigments.

A standard gray paint containing carbon black and titanium dioxide as a main pigment may be used. Paint can have a brightness and a hue compatible with a top coating paint, or have various coloring pigment.

The pigment is preferably contained in the aqueous intermediate paint in such an amount that a ratio of pigment weight relative to a total weight of all resin solid contents and pigment contained in an aqueous intermediate coating paint (PWC; pigment weight content) is within the range of 10 to 60% by weight. When the content is smaller than 10% by weight, opacifying properties may reduce. When the content exceeds 60% by weight, viscosity increases at curing and flowability reduces to result in deterioration in appearance of the coated film.

It is preferable that a content of the pigment dispersant is a lower limit of 0.5% by weight and an upper limit of 10% by weight based on a weight of the pigment. When the content is smaller than 0.5% by weight, since an amount of the pigment dispersant to be incorporated is small, dispersion stability of a pigment is inferior in some cases. When the content exceeds 10% by weight, physical properties of the coated film are inferior in some cases. Preferably, the lower limit is 1% by weight, and the upper limit is 5% by weight.

The thickener is not particularly limited, but examples include cellulose series such as viscose, methylcellulose, ethylcellulose, hydroxyethylcellulose and, as a commercially available product, Tylose MH and Tylose H (all trade name manufactured by Hoechst); alkali viscosity increasing type such as sodium polyacrylate, polyvinyl alcohol, carboxymethylcellulose and, as a commercially available product (hereinafter, all trade name), Primal ASE-60, Primal TT-615 and Primal RM-5 (all manufactured by Rohm & Haas, Inc.), and Ukarpolyfove (manufactured by Union Carbide); and association type such as polyvinyl alcohol, polyethylene oxide and, as a commercially available product (hereinafter, all trade name), Adecanol UH420, Adecanol UH462, Adecanol UH472, UH-540, and Adecanol UH-814N (manufactured by Asahi Denka Co., Ltd.), Primal RH-1020 (manufactured by Rohm & Haas, Inc.), and Kuraray poval (manufactured by Kuraray Co., Ltd.). These may be used alone or in combination of two or more.

The inclusion of the thickener can increases a viscosity of an aqueous intermediate coating paint and, upon coating of an aqueous intermediate coating paint, sagging can be inhibited. In addition, layer mixing between an intermediate coating film and a base coating film can be suppressed. As a result, coating workability is improved, and excellent finished appearance of the resulting coated film can be obtained.

It is preferable that a content of the thickener is a lower limit of 0.01 part by weight and an upper limit of 20% parts by weight based on 100 parts by weight of a resin solid content of the aqueous intermediate coating paint (solid content of all resins contained in aqueous intermediate coating paint). It is more preferable that a lower limit is 0.1 part by weight, and an upper limit is 10 parts by weight. When the content is smaller than 0.01 part by weight, viscosity increasing effect is not obtained, and sagging may occur when coating. When the content exceeds 20 parts by weight, appearance and various performances of the resulting coated film may reduce.

Examples of other additives include, in addition to the above mentioned components, additives which are usually added, such as a ultraviolet absorbing agent; an antioxidant; an anti-foaming agent; a surface adjusting agent; a pinhole preventing agent. Contents of the additives may be within the range known to a person skilled in the art.

The aqueous intermediate coating paint used in the present invention is prepared by mixing the acrylic resin emulsion, urethane resin emulsion and curing agent. A ratio of the acrylic resin emulsion and the urethane resin emulsion is 1/1 to 2/1 as expressed by a solid weight ratio. When the ratio is smaller than 1/1, a viscosity of a coating film is high, smoothness of an intermediate coating is reduced, and appearance is deteriorated. When the ratio exceeds 2/1, water absorption rate and dissolving rate are increased, and appearance is deteriorated.

The curing agent is used in an amount that a lower limit is 2% by weight and an upper limit is 50% by weight, preferably a lower limit is 4% by weight and an upper limit is 40% by weight, more preferably a lower limit is 5% by weight, and upper limit is 30% by weight based on a total amount of solid content of the curing agent, the acrylic resin emulsion and the urethane resin emulsion. When the amount is smaller than 2% by weight, water resistance of the resulting coated film is reduced. On the other hand, when the amount exceeds 50% by weight, chipping properties of the resulting coated film is reduced.

Additional resin components, a pigment dispersion paste and other additives may be mixed at an appropriate amount. It is preferable that additional resin components are incorporated in an amount of 50% by weight or less based on a solid content of all resins contained in an aqueous intermediate coating paint composition. When they are incorporated in an amount exceeding 50% by weight, it is difficult to increase the solid content in a paint.

These components may be added before or after the curing agent is added to the emulsion. A form of the aqueous intermediate coating paint is not particularly limited as far as it is aqueous, such as water-soluble, water dispersion-type and aqueous emulsion forms.

Aqueous Base Paint

The aqueous base paint used in the present method is a paint composition which is usually used as an aqueous intermediate coating paint for automobiles. Examples include paint which contains a film forming resin, a curing agent, a luster pigment, a pigment such as a coloring pigment and a filler pigment, and various additives, dispersed or dissolved in an aqueous medium. As the film forming resin, for example, a polyester resin, an acrylic resin, a urethane resin, a carbonate resin and an epoxy resin can be used. From a viewpoint of pigment dispersibility and workability, a combination of an acrylic resin and/or a polyester resin and a melamine resin is preferable. A curing agent, a pigment and various additives which are usually used can be employed.

The pigment concentration (PWC) in the aqueous base paint is generally a lower limit of 0.1% by weight and an upper limit of 50% by weight, more preferably a lower limit of 0.5% by weight and an upper limit of 40% by weight, more preferably a lower limit of 1% by weight and an upper limit of 30% by weight. When the pigment concentration is smaller than 0.1% by weight, effects derived from a pigment can not be obtained and, when the concentration exceeds 50% by weight, appearance of the resulting coated film is deteriorated.

The aqueous base paint can be prepared by a same method as that for the intermediate coating paint. A form of the aqueous base paint is not particularly limited as far as it is aqueous, such as water-soluble, water dispersion-type and aqueous emulsion forms.

Clear Paint

The clear paint used in the present method may be a paint composition which is usually as a clear paint for automobiles. Examples include paint compositions which contain a film forming resin, a curing agent and other additives, dispersed or dissolved in a medium. Examples of the film forming resin include an acrylic resin, a polyester resin, an epoxy resin and a urethane resin. The resins are used by combining with a curing agent such as an amino resin and/or an isocyanate resin. From a viewpoint of transparency or acid etching resistance, it is preferable to use a combination of an acrylic resin and/or a polyester resin and an amino resin, or an acrylic resin and/or a polyester resin having carboxylic acid epoxy curing system.

A form of the clear coating paint may be any of organic solvent-type aqueous-type (water-soluble, water-dispersible, emulsion), non-water dispersible-type and powder type. If necessary, a curing catalyst and a surface adjusting agent may be contained.

Method for Forming Plural-layered Coated Film

In the method for forming a plural-layered coated film of the present invention, an article to be coated is coated with an electrodeposition coated film. The electrodeposition coated film is formed by coating an electrodeposition coating paint on the article to be coated and baking and curing it. The article to be coated is not particularly limited as far as it is a metal product which can be cation-electrodeposition coated. Examples include iron, copper, aluminum, tin and zinc and alloy containing these metals, as well as products plated or deposited with the metals.

The electrodeposition coating paint is not particularly limited, but the known cation electrodeposition coating paint and anion electrodeposition coating paint may be used. Electrodeposition coating and baking may be performed by the methods and conditions which are usually used for electrodeposition coating an automobile body.

Then, an aqueous intermediate coating paint is coated on an electrodeposition coated film to form an intermediate coating film. The intermediate coating paint can be coated, for example, by spraying using air electrostatic spray usually called “react gum”, or rotation atomizing type electrostatic coating machines usually called “micro·microbel (μμbel)”, “microbel (μbel)” or “metallic bel (metabel)”.

A coating amount is controlled such that a thickness of a coating film after curing is ˜10 to 40 μm, preferably 15 to 30 μm. When the thickness is smaller than 10 μm, appearance and anti-chipping property of the resulting coated film are deteriorated. When the thickness exceeds 40 μm, disadvantages such as sagging when coating and pinhole when baking and curing may occur in some cases.

It is preferable that the intermediate coating film is dried by heating or air-blowing before an aqueous base paint is coated. This is because, when drying is insufficient, water remaining in a coating film is suddenly boiled at a step of baking a plural-layered coating film, and pinhole occurs. Also, upon coating of a base paint on an intermediate coating, the intermediate coating is mixed with the base paint, and appearance is deteriorated. It is preferable that a dried intermediate coating film is poor in water absorption rate. The poor water absorption rate sufficiently prevents water contained in the aqueous base paint from invading into the intermediate coating film and inhibits increase of solid content of the base paint to result in improvement of flowability of the coated film and enhancement of smoothness of the surface of the base coating film. As the result, the final plural-layered coated film has good surface smoothness.

Specifically, the aqueous intermediate coating paint has a water absorption rate of 10% or less. The water absorption rate of coating film is determined by that: A base paint is coated at a thickness of 20 μm on a substrate to form an initial base coating film, and then dried at 80° C. for 5 minutes to obtain a pre-dried coating film. The pre-dried coating film is immersed in water for 2 minutes in which a water content absorbed in the pre-dried coating film is calculated based on the weight of the initial base coating film after coating.

In addition, it is preferable that a component which is dissolved into water from the dried intermediate coating film is contained in a small amount. When the aqueous base paint is coated on an intermediate coating film, water-dissolving components are dissolved out with water of the aqueous base paint, and are easily transferred to a base coating film. Then, strain is generated at an interface between the intermediate coating film and the base coating film. As a result, it is considered that appearance of the surface of a plural-layered coating film is deteriorated.

Specifically, the aqueous intermediate coating paint has a water-dissolving rate of 5% or less. The water dissolving rate of coating film is determined as follows: the pre-dried coating film is immersed in water for 2 minutes, in which a weight rate of an amount of components dissolved out from the intermediate coating film to the pre-dried coating film is calculated.

Calculation of the water absorption rate of coating film and the water dissolving rate of coating film can be performed, for example, as follows: an aqueous intermediate coating paint is spray-coated on two aluminum foils of aluminum A and aluminum B at a thickness of 20 μm. These are pre-dried at 80° C. for 5 minutes and, among them, aluminum B is immersed in pure water for 2 minutes. Thereafter, aluminum A and B are dried at 140° C. for 20 minutes. In the series steps, a weight of an aluminum foil is defined as follows:

TABLE 1

| | |
|---|---|
| Initial weight of aluminum A | A0 |
| Initial weight of aluminum B | B0 |
| Weight of aluminum A after intermediate coating | A1 |
| Weight of aluminum B after intermediate coating | B1 |
| Weight of aluminum B after water immersion | B2 |
| Weight of aluminum A after drying at 140° C. | A3 |
| Weight of aluminum B after drying at 140° C. | B3 |
| Non-volatile matters after pre-drying of aluminum foil A (%) | a |
| Non-volatile matters of intermediate coating before immersion of | b |
| aluminum foil B (%) | |
| Non-volatile matters of intermediate coating after immersion of | c |
| aluminum foil B (%) | |
| Weight of components dissolved out upon immersion of | d |
| aluminum foil B | |

Then, a and b are expressed as follows:

TABLE 2

| | |
|---|---|
| a | (A3 − A0)/(A1 − A0) × 100 |
| b | (B3 − B0)/(B1 − B0) × 100 |
| c | (B3 − B0)/(B2 − B0) × 100 |
| d | ((B1 − B0) × a/100 − (B3 − B0)) × 100 |

A water absorption rate and a water dissolving rate are expressed by the following equations:

Water absorption rate of coating film (%)=(1-c/a)×100 (Equation 1)

Water dissolving rate of coating film (%)=(d/((B1-B0)×a/100)) (Equation 2)

The water absorption rate and water-dissolving rate of the intermediate coating film can be suppressed low by using a combination of the acrylic resin emulsion and the urethane resin emulsion as a resin component of the aqueous intermediate coating paint. The urethane resin emulsion does not participate in curing, but easily form strong film by melting. It is considered that the incorporation of the urethane resin emulsion in an intermediate coating paint forms a barrier in the coated film and prevents permeation of water and transference of dissolved components.

Then, an aqueous base paint and a clear paint are successively coated on an intermediate coating film in a wet-on-wet manner without curing the intermediate coating film, to form a base coating film and a clear coating film. Herein, wet-on-wet coating refers to coating plural coating films by overlaying without curing.

An amount of the aqueous base paint to be coated is controlled such that a coating film after curing has a thickness of 10 to 30 μm. When the thickness after curing is smaller than 10 μm, opacifying ability of the under layer may be insufficient, and unevenness in color may occur. On the other hand, when the thickness exceeds 30 μm, sagging may occur when coating, and pinhole occurs when heating and curing.

An amount of the clear paint to be coated is controlled such that a coating film after drying and curing has a thickness of 10 to 70 μm. When the thickness after curing is smaller than 10 μm, appearance such as luster appearance of a plural-layered coating film is deteriorated. When the thickness exceeds 70 μm, clearness is reduced, and disadvantages such as unevenness and sagging occur when coating.

Then, the intermediate coating film, the base coating film and the clear coating film are baked and cured at the same time. Baking is performed by heating to a temperature of 110 to 180° C., preferably 120 to 160° C. Thereby, a cured coated film having a high crosslinking degree can be obtained. When a heating temperature is lower than 110° C., curing is insufficient. When a: heating temperature exceeds 180° C., the resulting coated film is hard and brittle. A heating time can be appropriately set depending on temperature and, for example, is 10 to 60 minutes when a temperature is 120 to 160° C.

### EXAMPLES

The present invention will be explained in detail below by way of Examples, but the present invention is not limited to Examples. In Examples, “part” means “part by weight” unless otherwise indicated.

### Example 1

(A) Preparation of Aqueous Intermediate Coating Paint

(Preparation of Pigment Dispersion Paste)

4.5 Parts of a commercially available dispersant “Disperbyk 190” (nonionic·anionic dispersant manufactured by Byk-Chemie, trade name), 0.5 part of an anti-foaming agent “BYK-011” (anti-foaming agent manufactured by Byk-Chemie), 22.9 parts of ion-exchanged water and 72.1 parts of rutile-type titanium dioxide were pre-mixed, a glass beads medium was added in a paint conditioner, and the pre-mixed materials were mixed in the paint conditioner and dispersed to a particle size of 5 μm or smaller at room temperature to obtain a pigment dispersion paste.

(Preparation of Acrylic Resin Emulsion)

445 Parts of water and 5 parts of Neucol 293 (manufactured by Nippon Nyukazai Co., Ltd.) were placed into a reaction vessel for preparing a usual acrylic-based resin emulsion, which is equipped with a stirrer, a thermometer, a dropping funnel, a refluxing condenser and a nitrogen introducing tube, and a temperature was risen to 75° C. while stirring. A mixture of the following monomer mixture (acid value of resin: 18, hydroxy group value of resin: 85, Tg of resin: −22° C.), 240 parts of water and 30 parts of Neucol 293 (manufactured by Nippon Nyukazai Co., Ltd.) was emulsified using a homogenizer, and the monomer pre-emulsion was added dropwise to the reaction vessel over 3 hours while stirring. At the same time with addition of the monomer pre-emulsion dropwise, an aqueous solution in which 1 part of APS (ammonium persulfate) as a polymerization initiator was dissolved in 50 parts of water was uniformly added dropwise to the reaction vessel until completion of addition of the monomer pre-emulsion dropwise. After addition of the monomer pre-emulsion dropwise, the reaction was continued at 80° C. for 1 hour, and cooled. After cooling, an aqueous solution in which 2 parts of dimethylaminoethanol was dissolved in 20 parts of water was placed therein to obtain the aqueous acrylic resin emulsion (Resin 1) having a non-volatile matter of 40.6% by weight.

TABLE 3
(Composition of monomer mixture)

| | |
|---|---|
| Methyl methacrylate | 39 Parts |
| Butyl acrylate | 271 Parts |
| Styrene | 50 Parts |
| 4-Hydroxybutyl acrylate | 103 Parts |
| Methacrylic acid | 8 Parts |
| Ethyl acrylate | 30 Parts |

A pH of the resulting acrylic resin emulsion was adjusted to 7.2 using a 30% aqueous dimethylaminoethanol solution.

(Preparation of Aqueous Intermediate Coating Paint)

55.5 Parts of the pigment dispersant paste and 83.7 parts of an acrylic resin emulsion, obtained as described above respectively, 56.7 parts of a urethane resin emulsion A (“ADEKA BONTIGHTER HUX-232” manufactured by Asahi Denka Co., Ltd.) and, as a curing agent, 9.3 parts of MYCOAT 723 (imino-type melamine resin manufactured by Mitsui Cytec Inc., trade name) were mixed, and 1.0 part of Adecanol UH-814N (urethane association-type thickener, active component 30%, manufactured by Asahi Denka Co., Ltd., trade name) was mixed therein, followed by stirring to obtain the aqueous intermediate coating paint.

(Measurement of Water Absorption Rate of Coating Film and Water Dissolving Rate of Coating Film)

Weights of two aluminum foils A and B having a size of 100 mm×55 mm were measured precisely to obtain A0=0.6492 g and B0=0.6496 g, respectively. The aqueous intermediate coating obtained in Example 1 was coated on the two aluminum foils by air spraying (thickness 20μ). After the two aluminum foils were allowed to stand for 2 minutes, pre-heated at 80° C. for 5 minutes, and weighed precisely to obtain A1=0.8404 g and B1=0.8167 g. Thereafter, only the aluminum foil B was immersed in pure water for 2 minutes, taken out, and water was slightly wiped and weighed precisely to obtain B2=0.8281 g. Thereafter, aluminum foils A and B were heated at 140° C. for 20 minutes, and weighed precisely to obtain A3=0.8376 g and B3=0.8140 g, respectively. According to the calculation method shown in Table 2, Formula 1 and Formula 2, a water absorption rate of an intermediate coating of 7%, and a water dissolving rate of coating film of 0.2% were obtained.

(B) Formation of Coating Film

Powerniks 110 (cationic electrodeposition coating paint manufactured by Nippon Paint Co., Ltd., trade name) was electrodeposition coated on a dull steel plate which had been treated with zinc phosphate, at a dry thickness of a coated film of 20 μm, heated and hardened at 160° C. for 30 minutes, and cooled to prepare a steel plate substrate.

The aqueous intermediate coating paint was coated on the resulting substrate at a thickness of 20 μm by air spraying coating, pre-heated at 80° C. for 5 minutes, Aqualex AR-2000 silver metallic (aqueous metallic base paint manufactured by Nippon Paint Co., Ltd., trade name) was coated at a thickness of 10 μm by air spraying coating, and pre-heated at 80° C. for 3 minutes. Further, MACFLOW O-1800W-2 clear (acid epoxy curing-type clear paint manufactured by Nippon Paint Co., Ltd., trade name) as a clear paint was coated on the coated plate at a thickness of 35 μm by air spraying coating, followed by heating and hardening at 140° C. for 30 minutes to obtain a test piece having plural-layered coated film.

Finished appearance of the plural-layered coated film obtained after heating and hardening was assessed with naked eyes. Assessment criteria are shown in Table 8. The results are shown in Table 4.

The aqueous intermediate coating paint, aqueous base paint and clear paint were diluted under the following conditions, and used for coating.

Aqueous intermediate coating paint

Thinner: ion-exchanged water

40 seconds/NO.4 Ford cup/20° C.

A paint solid content was 54% by weight.

Aqueous base paint

Thinner: ion-exchanged water

45 seconds/No.4 Ford cup/20° C.

Clear paint

Thinner: mixed solvent of EEP (ethoxyethyl propionate)/S-150 (aromatic hydrocarbon solvent manufactured by Exxon, trade name)=1:1 ratio by weight

30 seconds/No.4 Ford cup/20° C.

### Preparation Example

Synthesis of Acrylic Emulsion

According to the same manner as that of “Preparation of Resin 1” except that the following monomer mixture was used, polymerization afforded the acrylic resin emulsion (Resin 2) having a non-volatile matter of 40.6%.

TABLE 4

| | |
|---|---|
| Methyl methacrylate | 83 Parts |
| Butyl acrylate | 231 Parts |
| Styrene | 62 Parts |
| 4-Hydroxybutyl acrylate | 110 Parts |
| Methacrylic acid | 14 Parts |
| Divinylbenzene | 20 Parts |

### Examples 2 to 9 and Comparative Examples 1 and 2

According to the same manner as that of Example 1 except that acrylic resin emulsions and urethane resin emulsions shown in the following Table 5, and Tables 6 to 8 were used, intermediate coating paints and plural-layered coated films were formed, and these were assessed. The results are shown in Table 5.

TABLE 5

| | | | | Water | Water- | |
|---|---|---|---|---|---|---|
| | | | Curing | absorption | dissolving | |
| | Acrylic | Urethane | agent | rate | rate | Appearance |
| Example 1 | Resin 1 | Resin A | Melamine A | 7 | 0.2 | ◯Δ |
| Example 2 | Resin 1 | Resin B | Melamine A | 8 | 2.7 | ◯Δ |
| Example 3 | Resin 2 | Resin A | Melamine A | 7 | 1.5 | ◯ |
| Example 4 | Resin 2 | Resin B | Melamine A | 6 | 0.5 | ◯ |
| Example 5 | Resin 2 | Resin C | Melamine A | 7 | 0.3 | ◯ |
| Example 6 | Resin 2 | Resin D | Melamine A | 8 | 0.8 | ◯ |
| Example 7 | Resin 2 | Resin E | Melamine A | 6 | 0.3 | ◯ |
| Example 8 | Resin 2 | Resin F | Melamine A | 6 | 1.2 | ◯ |
| Example 9 | Resin 2 | Resin A | Melamine B | 8 | 3.5 | ◯ |
| Comparative | Resin 1 | — | Melamine A | 19 | 9.2 | X |
| Example 1 | | | | | | |
| Comparative | Resin 2 | — | Melamine A | 17 | 8.3 | X |
| Example 2 | | | | | | |

*Data values used as a base of calculation are shown in Table 10 and Table 11

TABLE 6
Acrylic resin

| | |
|---|---|
| Resin 1 | Example 1 |
| Resin 2 | Preparation Example |

TABLE 7
Urethane resin

| | | Acid value |
|---|---|---|
| | Kind of resins | (mgKOH/g) |
| Resin A | “ADEKA BONTIGHTER HUX-232” | 30 |
| | manufactured by Asahi Denka Co., Ltd. | |
| Resin B | “ADEKA BONTIGHTER HUX-386” | 25 |
| | manufactured by Asahi Denka Co., Ltd. | |
| Resin C | “ADEKA BONTIGHTER HUX-380” | 15 |
| | manufactured by Asahi Denka Co., Ltd. | |
| Resin D | “Bayhydrol VPLS2303” manufactured by | 9 |
| | Sumitomo Bayer Urethane | |
| Resin E | “Bayhydrol VPLS2341” manufactured by | 10 |
| | Sumitomo Bayer Urethane | |
| Resin F | “Bayhydrol VPLS2438” manufactured by | 25 |
| | Sumitomo Bayer Urethane | |

TABLE 8
Curing agent

| | |
|---|---|
| Melamine A | “MYCOAT 723” manufactured by Mitsui Cytec Inc. |
| Melamine B | “CYMEL 327” manufactured by Mitsui Cytec Inc. |

TABLE 9
Criteria for assessing appearance (smoothness)
of plural-layered coated film

| | |
|---|---|
| ◯ | Good |
| ◯Δ | Slightly worse |
| Δ | Marginal |
| X | Poor |

TABLE 10

| | Example 1 | Example 2 | Example 3 | Example 4 | Example 5 |
|---|---|---|---|---|---|
| A0 | 0.6492 | 0.6493 | 0.6514 | 0.6499 | 0.6462 |
| B0 | 0.6496 | 0.6495 | 0.6514 | 0.6480 | 0.6469 |
| A1 | 0.8404 | 0.7791 | 0.8009 | 0.8665 | 0.8733 |
| B1 | 0.8167 | 0.7792 | 0.7835 | 0.8089 | 0.8520 |
| B2 | 0.8281 | 0.7860 | 0.7919 | 0.8175 | 0.8657 |
| A3 | 0.8376 | 0.7741 | 0.7945 | 0.8631 | 0.8561 |
| B3 | 0.8140 | 0.7708 | 0.7760 | 0.8056 | 0.8359 |
| Water | 7 | 8 | 7 | 6 | 7 |
| absorption | | | | | |
| rate (%) | | | | | |
| Water | 0.2 | 2.7 | 1.5 | 0.5 | 0.3 |
| dissolving | | | | | |
| rate (%) | | | | | |

TABLE 11

| | | | | | Comparative | Comparative |
|---|---|---|---|---|---|---|
| | Example 6 | Example 7 | Example 8 | Example 9 | Example 1 | Example 2 |
| A0 | 0.6561 | 0.6564 | 0.6581 | 0.6473 | 0.6549 | 0.6577 |
| B0 | 0.6587 | 0.6588 | 0.6559 | 0.6461 | 0.6565 | 0.6580 |
| A1 | 0.7810 | 0.8590 | 0.8374 | 0.8840 | 0.8608 | 0.9356 |
| B1 | 0.7825 | 0.8504 | 0.8149 | 0.8750 | 0.9127 | 0.9504 |
| B2 | 0.7925 | 0.8618 | 0.8224 | 0.8933 | 0.9442 | 0.9825 |
| A3 | 0.7756 | 0.8425 | 0.8304 | 0.8679 | 0.8482 | 0.9172 |
| B3 | 0.7762 | 0.8342 | 0.8068 | 0.8556 | 0.8749 | 0.9084 |
| Water | 8 | 6 | 6 | 9 | 19 | 17 |
| absorption | | | | | | |
| rate (%) | | | | | | |
| Water | 0.8 | 0.3 | 1.2 | 1.8 | 9.2 | 8.3 |
| dissolving | | | | | | |
| rate (%) | | | | | | |

According to the method for forming a coated film of the present invention, a plural-layered coated film excellent in surface smoothness can be formed while phase mixing between an intermediate coating film and a base coating film is effectively prevented.

What is claimed is:

1. A method for forming a plural-layered coated film, which comprises (1) a step of providing an article with an electrodeposition coating film; (2) a step of coating an aqueous intermediate coating paint on the electrodeposition coating film to form an intermediate coating film; (3) a step of successively coating an aqueous base paint and a clear paint on the intermediate coating film in a wet-on-wet manner without curing the intermediate coating film, to form a base coating film and a clear coating film; and (4) a step of baking and curing the intermediate coating film, the base coating film and the clear coating film at the same time,
wherein the intermediate coating film formed from the aqueous intermediate coating paint has a water absorption rate of coating film of 10% or less and a water dissolving rate of coating film of 5% or less, and
the aqueous intermediate coating paint comprises:
an acrylic resin emulsion having a glass transition temperature of −50 to 20° C., and an acid value of 2 to 60 mgKOH/g and a hydroxy group value of 10 to 120 mgKOH/g,
an urethane resin emulsion having an acid value of 5 to 50 mgKOH/g, and
a curing agent.

2. The method according to claim 1, wherein the acrylic resin emulsion is one obtained by emulsion-polymerizing a monomer mixture of (a) (meth)acrylic acid alkyl ester, (b) acid group-containing ethylenic unsaturated monomer, and (c) hydroxy group-containing ethylenic unsaturated monomer.

3. The method according to claim 1, wherein a ratio of the acrylic resin emulsion and the urethane resin emulsion is 1/1 to 2/1 expressed as a solid content by weight.
